(19) United States
(12) Patent Application Publication
(10) Pub. No.: US 2025/0008165 A1
(43) Pub. Date: Jan. 2, 2025

(54) VIDEO PROCESSING APPARATUS, METHOD, AND PROGRAM

(71) Applicant: NIPPON TELEGRAPH AND TELEPHONE CORPORATION, Tokyo (JP)

(72) Inventors: Motohiro MAKIGUCHI, Tokyo (JP); Takahiro MATSUMOTO, Tokyo (JP); Wakana OSHIRO, Tokyo (JP); Masanori YOKOYAMA, Tokyo (JP); Ryuji YAMAMOTO, Tokyo (JP); Yuta NAMBU, Tokyo (JP)

(73) Assignee: NIPPON TELEGRAPH AND TELEPHONE CORPORATION, Tokyo (JP)

(21) Appl. No.: 18/709,520

(22) PCT Filed: Nov. 30, 2021
(86) PCT No.: PCT/JP2021/043780

§ 371 Date: May 13, 2024

(51) Int. Cl. H04N 21/218; H04N 23/698

(52) U.S. Cl. CPC H04N 21/21805; H04N 23/698

(57) ABSTRACT

A video processing device according to an embodiment includes: a calculation unit that calculates capturing directions of videos in which a subject is captured from third-party viewpoints by a plurality of 360 degree cameras on the basis of position information on the subject and position information on the plurality of 360 degree cameras each capturing a video in a range of 360 degrees around; a selection unit that selects a capturing direction in which a desired subject by a user who is not the subject is captured from a third-party viewpoint and that is a desired capturing direction by the user, from the capturing directions calculated by the calculation unit; and an output unit that outputs a video in a range including the desired subject in a video captured by one of the 360 degree cameras capable of performing capturing in the capturing direction selected by the selection unit.

### TECHNICAL FIELD

An embodiment of the present invention relates to a video processing device, method, and program.

### BACKGROUND ART

In video acquisition of a competition performed in a place far from land or a place with many obstacles, such as windsurfing performed on the sea or bicycle motocross (BMX) competition in which riding on a mountain bike (MTB) is performed on a course in the forest, it is difficult to follow a state of a player in the competition with a fixed telephoto camera.

For this reason, to capture a third-party viewpoint video that is a video of a player captured from close proximity in the competition as described above, a method using a mobile camera is adopted such as causing a boat for imaging or a drone for imaging to follow the player.

In this method using the mobile camera, the boat for imaging or the drone for imaging has a limitation on the number of cameras that can run side by side without disturbing the competition and a route limitation such as not allowing the camera to enter the course, and a problem is difficulty of following a professional player moving at a high speed, for example.

As a method capable of solving such a problem, it is conceivable to apply a method of connecting a balloon or a float on which a camera is mounted to a player oneself with a long string, and causing the player to pull the connected balloon or float to acquire a third-party viewpoint video (for example, see Non Patent Literature 1).

### CITATION LIST

### Non Patent Literature

Non Patent Literature 1: Masaharu Hirose, Yuta Sugiura, Kouta Minamizawa, Masahiko Inami, Bukubucam: Recording the third-person View in SCUBA Diving, Information Processing Society of Japan, Entertainment Computing Symposium 2014 (EC2014) Proceedings, 142-145, 2014 Sep. 12

### SUMMARY OF INVENTION

### Technical Problem

However, in the method as described above, it is necessary to separate the camera and the player from each other over a certain amount of distance, and there is a problem that camerawork is restricted, for example, when the player moves at a high speed or when the player passes through a limited space, the connected camera becomes an obstacle, and in addition, a capturing direction of the camera is fixed depending on a moving direction of the player, and for example, only the player's back viewpoint video can be acquired.

The present invention has been made in view of the above circumstances, and an object thereof is to provide a video processing device, method, and program capable of appropriately acquiring a third-party viewpoint video.

### Solution to Problem

A video processing device according to an aspect of the present invention includes: a calculation unit that calculates capturing directions of videos in which a subject is captured from third-party viewpoints by a plurality of 360 degree cameras on the basis of position information on the subject and position information on the plurality of 360 degree cameras each capturing a video in a range of 360 degrees around; a selection unit that selects a capturing direction in which a desired subject by a user who is not the subject is captured from a third-party viewpoint and that is a desired capturing direction by the user, from the capturing directions calculated by the calculation unit; and an output unit that outputs a video in a range including the desired subject in a video captured by one of the 360 degree cameras capable of performing capturing in the capturing direction selected by the selection unit.

A video processing method according to an aspect of the present invention is a video processing method performed by a video processing device, the video processing method including: calculating, by the video processing device, capturing directions of videos in which a subject is captured from third-party viewpoints by a plurality of 360 degree cameras on the basis of position information on the subject and position information on the plurality of 360 degree cameras each capturing a video in a range of 360 degrees around; selecting, by the video processing device, a capturing direction in which a desired subject by a user who is not the subject is captured from a third-party viewpoint and that is a desired capturing direction by the user, from the capturing directions calculated; and outputting, by the video processing device, a video in a range including the desired subject in a video captured by one of the 360 degree cameras capable of performing capturing in the capturing direction selected.

### Advantageous Effects of Invention

According to the present invention, it is possible to appropriately acquire a third-party viewpoint video.

### BRIEF DESCRIPTION OF DRAWINGS

FIG. 1 is a diagram illustrating an application example of a video processing system according to an embodiment of the present invention.

FIG. 2 is a diagram illustrating an example of positional relationships between players, and camera angles at which third-party viewpoint videos of the players can be displayed.

FIG. 3 is a diagram for explaining an example of installation of 360 degree cameras in windsurfing.

FIG. 4 is a flowchart illustrating an example of a processing procedure by units of the video processing system.

FIG. 5 is a top view illustrating an example of a blind spot range regarding a 360 degree camera.

FIG. 6 is a diagram illustrating an example of an azimuth and a distance from a 360 degree camera to a target player.

FIG. 7 is a diagram illustrating an example of setting of an effective camera based on a difference in azimuth.

FIG. 8 is a diagram illustrating an example of a display screen for effective camera angles for players by thumbnails.

FIG. 9 is a diagram illustrating an example of the display screen for the effective camera angles for the players by map information.

FIG. 10 is a diagram for explaining an example of cutting out a planar video from a 360 degree video.

FIG. 11 is a diagram for explaining the example of cutting out the planar video from the 360 degree video.

FIG. 12 is a diagram for explaining the example of cutting out the planar video from the 360 degree video.

FIG. 13 is a diagram for explaining the example of cutting out the planar video from the 360 degree video.

FIG. 14 is a diagram illustrating an example of selection of a camera angle at which a plurality of players can be captured from a third-party viewpoint.

FIG. 15 is a diagram illustrating an example of setting of the blind spot range using position information on an obstacle.

FIG. 16 is a diagram illustrating an example of the setting of the blind spot range using the position information on the obstacle.

FIG. 17 is a block diagram illustrating an example of a hardware configuration of a video processing device according to the embodiment of the present invention.

### DESCRIPTION OF EMBODIMENTS

Hereinafter, an embodiment according to the present invention will be described with reference to the drawings.

In the present embodiment, a description will be given of a device that acquires a video during a competition by attaching a 360 degree camera (hereinafter, may be simply referred to as a camera) capable of recording a video in a range of 360 degrees around (hereinafter, may be referred to as a 360 degree video or a 360 degree camera video) to each of boats steered by a respective plurality of players who are subjects, for example, a boat A steered by a player A, a boat B steered by a player B, and a boat C steered by a player C, and extracts and reproduces a third-party viewpoint video of a player desired to be focused on by a user who is not the players, for example, by an audience, on the basis of position information on each camera and each player.

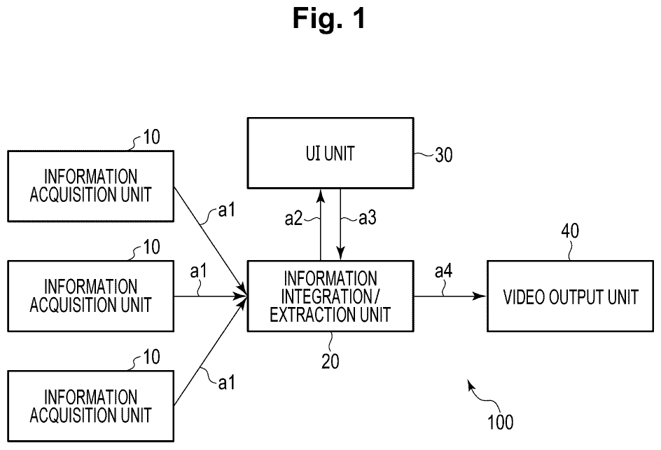

FIG. 1 is a diagram illustrating an application example of a video processing system according to an embodiment of the present invention.

The example illustrated in FIG. 1 illustrates a video processing system including information acquisition units (information acquisition devices) 10, an information integration/extraction unit (may also be referred to as an information integration unit) 20, a user interface (UI) unit 30, and a video output unit 40. The information integration/extraction unit 20, the UI unit 30, and the video output unit 40 that are elements of the above system can be configured as an integrated video processing device 100. At least two or more elements of the information integration/extraction unit 20, the UI unit 30, and the video output unit 40 may be an integrated element. The units, for example, each of the information acquisition units 10, and the information integration/extraction unit 20 can be communicably connected to each other by, for example, wireless communication.

In the present embodiment, the information acquisition units 10 are attached to the respective boats. Each information acquisition unit 10 includes a 360 degree camera that is a camera attached to each of the boats and is capable of recording a video of a range of 360 degrees around an attachment place on the boat, a global posting system sensor (GPS) sensor, a 9-axis sensor, and a communication device. The GPS sensor is a sensor capable of detecting latitude and longitude of each 360 degree camera and each player, and the 9-axis sensor is a sensor capable of detecting acceleration, orientation, and inclination of each 360 degree camera and each player. The 9-axis sensor may be a combination of an accelerometer, a gyroscope sensor, and an azimuth sensor.

Each of the information acquisition units 10 acquires the 360 degree camera video by the 360 degree camera, and the latitude and longitude, acceleration, orientation, and inclination of the 360 degree camera and each player, and sets blind spot information on the camera. Details of the acquisition of these or the setting will be described later.

In addition, the 360 degree camera may be directly attached to the player oneself, for example, the back of the head of the player, or may be attached to a place away to some extent from the back of the head of the player via an arm or the like connected to a headgear attached to the back of the head of the player.

Various types of information acquired or set by each of the information acquisition units 10 are sent to the information integration/extraction unit 20 by the communication device by, for example, wireless communication (reference sign a1 in FIG. 1). The information integration/extraction unit 20 detects positional relationships between the cameras and the players on the basis of the latitude and longitude detected by the GPS sensor of each of the information acquisition units 10.

In addition, on the basis of the detected positional relationships between the cameras and the players, the information integration/extraction unit 20 acquires, for each player, camera angles (may be referred to as an effective camera angles) at which third-party viewpoint videos of the players can be displayed, that is, capturing directions of videos in which the player who is a subject is captured from the third-party viewpoints, as capturing directions selectable by a user who is not the subject, and sends a result of the acquisition to the UI unit 30 together with information indicating the positional relationships between the players (reference sign a2 in FIG. 1). The third-party viewpoint videos each are a video obtained by cutting out a video of an angle of view in which a specific player fits from a video captured by each camera.

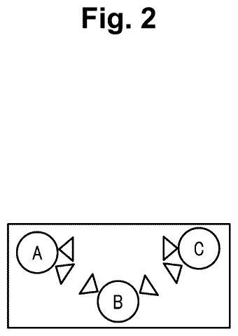

The UI unit 30 converts the positional relationships between the players, and the camera angles at which third-party viewpoint videos of the players can be displayed, which are indicated by information sent from the information integration/extraction unit 20, into map information, that is, visual information indicated in a map format, and presents a display screen of the map information to the user by displaying the display screen of the map information on a display device (not illustrated) of the UI unit 30. FIG. 2 is a diagram illustrating an example of the positional relationships between the players, and the camera angles at which third-party viewpoint videos of the players can be displayed. FIG. 2 illustrates map information regarding the positional relationships between the players A, B, and C and the camera angles (triangle marks in FIG. 2) at which the third-party viewpoint videos of the players A, B, and C.

The user can select a desired camera angle at which a third-party viewpoint video of a desired player by the user can be displayed among the camera angles at which third-party viewpoint videos of the players can be displayed indicated by the presented map information, that is, a desired capturing direction of a video in which a desired subject is captured from the third-party viewpoint, by a click operation or the like on the display screen of the map information displayed on the UI unit 30.

The information integration/extraction unit 20 acquires information on the selected camera angle (reference sign a3 in FIG. 1), and sends a 360 degree camera video captured by a 360 degree camera that can perform capturing at the camera angle to the video output unit 40 together with information regarding positions of the camera and the players (reference sign a4 in FIG. 1). The information regarding positions corresponds to an azimuth and a distance to be described later.

That is, the information integration/extraction unit 20 can select a capturing direction in which a desired subject by the user who is not the subject is captured from a third-party viewpoint and that is a desired capturing direction by the user, from the calculated capturing directions.

The video output unit 40 cuts out a planar video in a range including the desired player on the basis of information regarding positions of the cameras and the players, from a 360 degree video captured at the camera angle selected by the user as described above in the 360 degree camera video sent from the information integration/extraction unit 20, outputs the video, and displays the video on a screen of a display device (not illustrated), for example. That is, the video output unit 40 outputs a video in a range including the desired subject by the user in a video captured by a 360 degree camera capable of performing capturing in a capturing direction selected by the user.

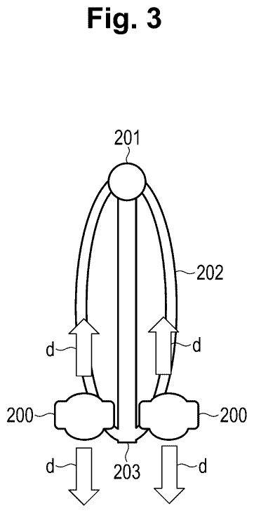

FIG. 3 is a top view for explaining an example of installation of 360 degree cameras in windsurfing.

In the example illustrated in FIG. 3, a 360 degree camera 200 is installed such that fronts of fisheye lenses respectively face in a front direction and a back direction (reference sign d in FIG. 3) of windsurfing in a boom end 203 at the rear of boom 202 connected to a mast 201 of a rig portion in windsurfing. With such installation, a 360 degree video from the height of the player's arm can be acquired.

In addition, in the example illustrated in FIG. 3, two 360 degree cameras 200 are attached in pairs to the respective booms 202 in the left and right connected to the mast 201. As a result, blind spots regarding the respective 360 degree cameras can be covered with each other.

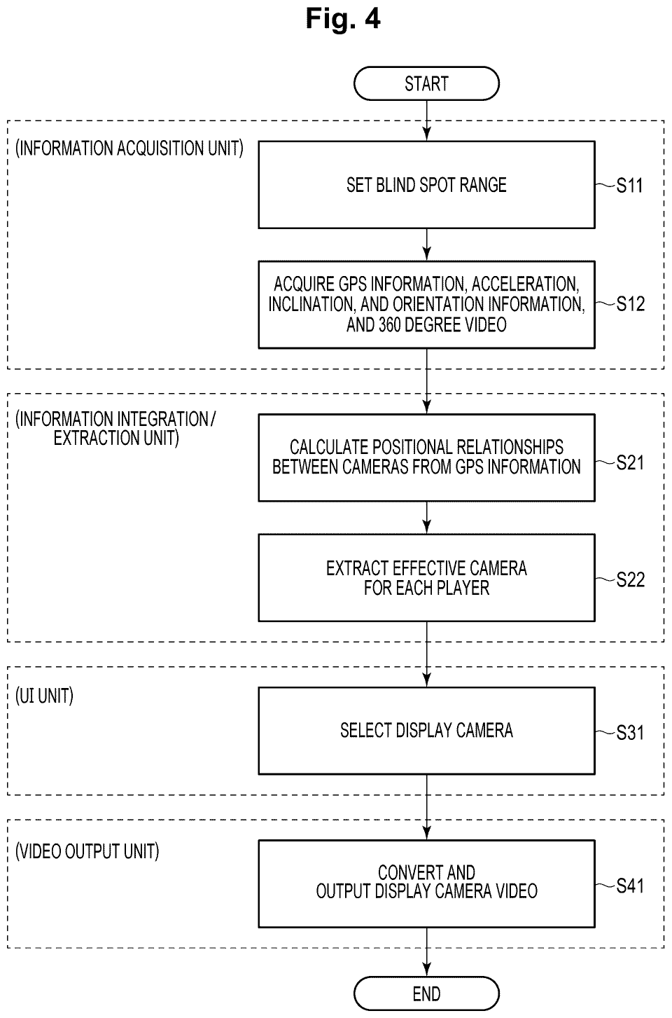

Next, a description will be given of an example of a processing procedure by the above units. FIG. 4 is a flowchart illustrating an example of a processing procedure by the units of the video processing system.

First, each information acquisition unit 10 sets, on the basis of an attachment position of a 360 degree camera in the information acquisition unit 10, an angle range that is a blind spot in capturing of the player by a shielding object in a video captured from the position, that is, a blind spot range that is a range in which the player who is a subject is not correctly captured due to the shielding object in a capturing range of the 360 degree camera (S11). Information on the set blind spot range is held in, for example, an information storage unit in the information acquisition unit 10.

In addition, the GPS sensor of each of the information acquisition units 10 acquires latitude and longitude information that is GPS information on each camera and each player, for each of time series. The 9-axis sensor of the information acquisition unit 10 acquires information on acceleration, inclination, and orientation of each camera and each player for each time series (S12). The 360 degree camera of the information acquisition unit 10 acquires a 360 degree video for each time series.

The set blind spot range, the acquired latitude and longitude information, information on acceleration, inclination, and orientation, and the 360 degree video are sent to the information integration/extraction unit 20 together with the information on the blind spot range, for each time series.

The information integration/extraction unit 20 sets one of the players as a target candidate (hereinafter, may be referred to as a target player), and repeats first processing and second processing below regarding the player for all the players, thereby creating a list of effective cameras for the players, that is, cameras that can perform capturing at camera angles at which third-party viewpoint videos of the players can be displayed (hereinafter, may be referred to as an effective camera list), for each of the players for each time series. The number of effective cameras regarding the players may be one or more.

As the first processing, the information integration/extraction unit 20 extracts a position of a 360 degree camera in which a distance to a player who is the target candidate is within a certain threshold, on the basis of the latitude and longitude information on each camera and each player from each of the information acquisition units 10, for each time series (S21).

As the second processing, the information integration/extraction unit 20 calculates an azimuth of the capturing range from the 360 degree camera at the extracted position to the player who is the target candidate (may be referred to as an azimuth from a 360 degree camera to a player in a target direction, or an azimuth to the player who is the target candidate) on the basis of the latitude and longitude information on each player from each of the information acquisition units 10. The information integration/extraction unit 20 compares the azimuth with the blind spot range set for each camera, thereby extracting a position of a camera, here, positions of a plurality of cameras, in which a part or all of the azimuth to the target player is not included in a part or all of the blind spot range, that is, there is no overlapping range between the azimuth and the blind spot range. The azimuth to the player who is the target candidate is an angle between an orientation that is a reference and an orientation facing the player who is the target candidate in the capturing range of the 360 degree camera.

The information integration/extraction unit 20 compares the azimuths to the target player calculated for the extracted positions of the respective cameras. When a difference between these azimuths is less than or equal to a first threshold, the information integration/extraction unit 20 extracts a camera having the closest distance to the target player, that is, a camera having a relatively short distance to the player, from among the plurality of extracted cameras, as an effective camera that is a camera capable of capturing the player from a third-party viewpoint in a capturing direction selectable by the user, and adds information on the camera, for example, information including position information and the capturing direction, to the effective camera list regarding the target player (S22). That is, the information integration/extraction unit 20 can calculate, as the capturing direction selectable by the user, a capturing direction when the azimuth of the capturing range of the 360 degree camera is not included in the blind spot range among the capturing directions of the 360 degree camera.

In addition, the information integration/extraction unit 20 can also add, among the extracted effective cameras, a camera having a difference from an azimuth regarding another camera greater than or equal to a second threshold greater than the first threshold to the effective camera list.

The information integration/extraction unit 20 outputs the effective camera list regarding each player to the UI unit 30, for example, as a thumbnail representing a camera angle for each time series at regular time intervals among time-series images captured from a camera angle at which a third-party viewpoint video of each player can be displayed, regarding an effective camera, or as map information in which positional relationships between effective cameras, and camera angles at which third-party viewpoint videos of the players can be displayed are visualized. The thumbnail is a thumbnail of a video captured in a capturing direction of a video in which a subject is captured from a third-party viewpoint in the video captured by the 360 degree camera.

The UI unit 30 lists and displays the effective camera list regarding each player output from the information integration/extraction unit 20 as the thumbnail or the map information. The UI unit 30 receives an operation by the user regarding selection of a desired effective camera angle regarding a desired target player among the effective camera angles regarding the players indicated by this information. In response to the operation, the information integration/extraction unit 20 outputs, to the video output unit 40, a 360 degree video captured by a 360 degree camera that can perform capturing at the selected angle, information indicating an azimuth from the 360 degree camera to the selected target player, and information indicating a distance between the 360 degree camera and the target player (S31).

The video output unit 40 cuts out a planar video on the basis of the azimuth from the camera to the target player and the distance between the camera and the target player with respect to various types of information output by the UI unit 30, that is, the 360 degree video captured at the effective camera angle selected by the user, and outputs and displays the planar video on the screen (S41).

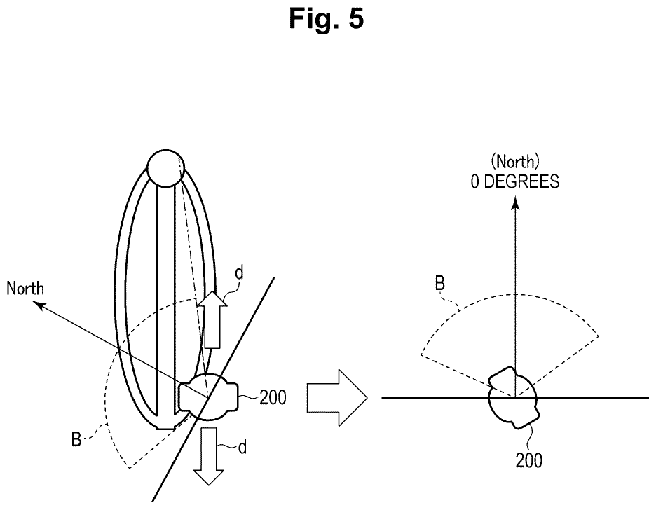

Next, a description will be given of calculation of a blind spot range regarding the attached 360 degree camera. FIG. 5 is a diagram illustrating an example of the blind spot range regarding the 360 degree camera.

In the present embodiment, a blind spot range (reference sign B in FIG. 5) with orientation of each 360 degree camera 200 as a reference is manually set on the basis of information on a blind spot generated due to the installation position of the 360 degree cameras 200 in windsurfing, for example, information on a blind spot that does not change with movement or rotation of a player, for example, generated due to the mast 201 in windsurfing.

FIG. 5 illustrates that the information acquisition unit 10 can convert the blind spot range B illustrated in a top view regarding the mast into the blind spot range B for each time series with the north as a reference of 0 degrees on the basis of a detection result by the azimuth sensor mounted on the 360 degree camera 200.

Next, a description will be given of calculation of the azimuth and the distance from the 360 degree camera to the target player based on the GPS information from the information acquisition unit 10 by the information integration/extraction unit 20.

The information integration/extraction unit 20 calculates the azimuth from each 360 degree camera to the target player and the distance between each 360 degree camera and the target player on the basis of the latitude and longitude of each camera and each player indicated by the GPS information from the information acquisition unit 10.

For example, it is assumed that latitude and longitude indicated by GPS information detected by a GPS sensor of each 360 degree camera are longitude L1[n] and latitude P1[n].

In addition, it is assumed that latitude and longitude indicated by GPS information detected by a GPS sensor of the target player are longitude L2 and latitude P2.

Then, a distance D between a 360 degree camera n and the target player, and an azimuth T from the 360 degree camera n to the target player are expressed by the following formulas (1) and (2), respectively.

$$D = Sqrt ( {X}^{2} + {Y}^{2} ) \qquad formula ( 1 )$$

$$T = atan 2 ( Y , X ) \qquad formula ( 2 )$$

X and Y in the formulas (1) and (2) are expressed by the following formulas (3) and (4), respectively.

$$X = R \times Δ L \times cos ( P 1 ) \qquad formula ( 3 )$$

$$Y = R \times Δ P \qquad formula ( 4 )$$

R in the formulas (3) and (4) is expressed as follows.
R=6378137 [m]: equatorial radius of the earth

ΔL in the formula (3) is expressed by the following formula (5), and ΔP in the formula (4) is expressed by the following formula (6).

$$Δ L = L 2 - L 1 [ n ] \qquad formula ( 5 )$$

$$Δ P = P 2 - P 1 [ n ] \qquad formula ( 6 )$$

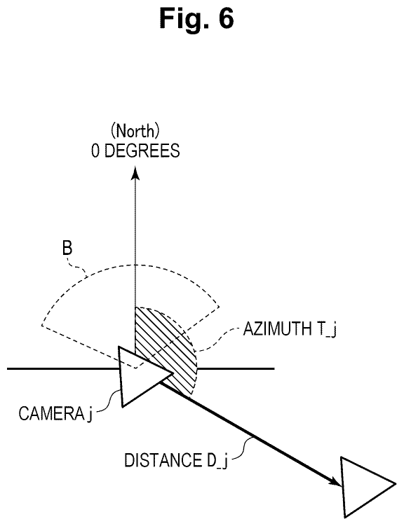

FIG. 6 is a diagram illustrating an example of the azimuth and the distance from the 360 degree camera to the target player.

The example illustrated in FIG. 6 illustrates a distance D_j between a camera j and the target player, an azimuth T_j from a reference orientation that is 0 degrees north to an orientation from the camera j to the target player (may be referred to as an azimuth from the camera j to the target player) in an angle of a capturing range of the camera j, and a blind spot range B of the camera j with 0 degrees north as a reference orientation. The azimuth T_j illustrated in FIG. 6 is an angle from the orientation of 0 degrees north that is the reference orientation to the orientation from the camera j to the target player.

In a case where the azimuth from the camera to the target player is included in the blind spot range of the camera, the camera is not selected as the effective camera by the information integration/extraction unit 20. In the example illustrated in FIG. 6, since a part of the azimuth T_j from the camera j to the target player is included in the blind spot range of the camera j, the camera j is not selected as an effective camera.

In addition, when video data for a certain period of time in recording or relaying by the camera can be accumulated in the information storage unit in the information acquisition unit 10, the user may be notified in a case where a camera angle that is being selected by the user or a camera angle displayed as a list falls within the blind spot range at a near future timing.

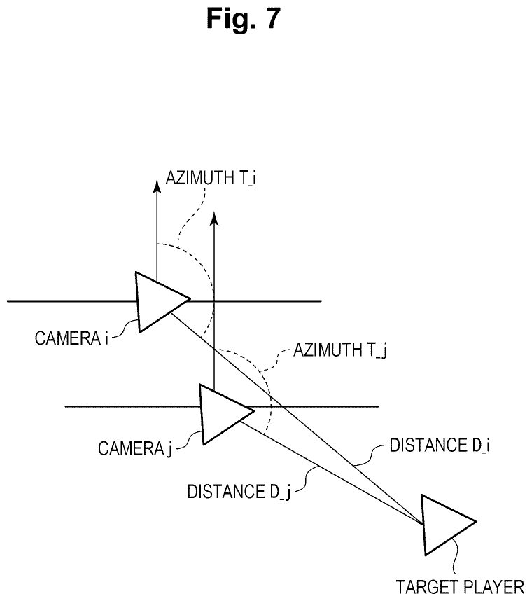

Next, a description will be given of narrowing down of the effective camera based on a difference in azimuth. FIG. 7 is a diagram illustrating an example of setting of the effective camera based on the difference in azimuth.

When the difference in azimuth from each camera to the target player is less than or equal to a certain threshold, angles of videos obtained by the cameras are substantially the same, so that the information integration/extraction unit 20 can set a camera having a closer distance to the target among the cameras as the effective camera.

In the example illustrated in FIG. 7, the information integration/extraction unit 20 compares a distance D_i between the camera i and the target player with a distance D_j between the camera j and the target player when an absolute value |T_i−T_j| of a difference between an azimuth T_i and an azimuth T_j is less than or equal to a threshold T′, the azimuth T_i being an azimuth from the reference orientation that is 0 degrees north to an orientation from a camera i to the target player (may be referred to as an azimuth from the camera i to the target player) in an angle of a capturing range of the camera i that is a first camera, the azimuth T_j being an azimuth from the reference orientation that is 0 degrees north to an orientation from the camera j to the target player (may be referred to as the azimuth from the camera j to the target player) in an angle of a capturing range of the camera j that is a second camera. By this comparison, the information integration/extraction unit 20 sets a camera having a smaller distance to the target player, that is, a camera closer to the target, as the effective camera.

This produces an effect of preventing other players from becoming obstacles.

Next, a description will be given of a display example of the effective camera angles for the players.

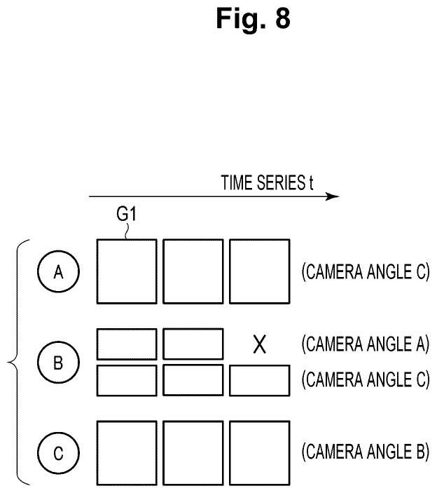

FIG. 8 is a diagram illustrating an example of the display screen for the effective camera angles for the players by thumbnails.

The information integration/extraction unit 20 can present the thumbnails representing the camera angles for each time series at regular time intervals by displaying the thumbnails on the screen in time series by the UI unit 30 for each player and each angle. In the example illustrated in FIG. 8, a thumbnail G1 of a captured video at a camera angle C at which the player A can be captured from a third-party viewpoint is displayed on the UI unit 30 for each time series (time) t of 10 seconds, thumbnails of captured videos at camera angles A and C at which the player B can be captured from third-party viewpoints are displayed on the UI unit 30 for each time series of 10 seconds, and a thumbnail of a captured video at a camera angle B at which the player C can be captured from a third-party viewpoint is displayed on the UI unit 30 for each time series of 10 seconds. The thumbnail is a thumbnail of a video in which a subject is captured from a third-party viewpoint in a capturing direction calculated for the subject in the video captured by the 360 degree camera.

The user selects a thumbnail corresponding to a desired camera angle regarding a desired player among the thumbnails displayed on the UI unit 30 by a click operation or the like, thereby being able to view a video at the designated camera angle for the player. In addition, a cross mark illustrated in FIG. 8 corresponds to a captured video at a camera angle that enters the blind spot among the camera angles.

In addition, in a case where there is no video at the selected camera angle, for example, in a case where the camera angle enters the blind spot, or in a case where the camera angle is likely to enter the blind spot, the information integration/extraction unit 20 can switch the video that can be viewed by the user on the UI unit 30 to a video at another camera angle in which the player is captured from a third-party viewpoint.

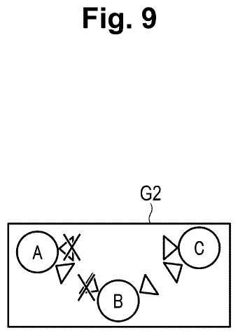

FIG. 9 is a diagram illustrating an example of the display screen for the effective camera angles for the players by the map information.

In addition to the display by the thumbnails, the information integration/extraction unit 20 can visualize the positional relationships between the players on a map G2 in real time by the UI unit 30 on the basis of the latitude and longitude information on each camera and each player, and display, as an arrow shaped button (button) on the UI unit 30, a camera angle at which the player on the map can be captured from a third-party viewpoint and that can be viewed by the user.

The user selects a button corresponding to a desired camera angle regarding a desired player among arrow shaped buttons displayed on the UI unit 30 by a click operation or the like, thereby being able to view a video at the designated camera angle for the player. In addition, a cross mark illustrated in FIG. 9 corresponds to a camera angle that enters the blind spot among the camera angles.

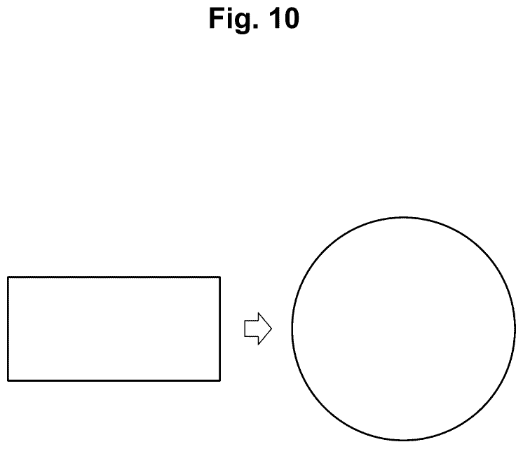

Next, a description will be given of cutting out a planar video from a 360 degree video by a 360 degree camera. FIGS. 10 to 13 are diagrams for explaining an example of cutting out a planar video from a 360 degree video.

First, as illustrated in FIG. 10, the video output unit 40 performs mapping of an omnidirectional video, for example, a DualFishEye image or an image generated by equidistant cylindrical projection, on a spherical surface in a virtual space.

Next, the video output unit 40 rotates a virtual sphere that is a sphere in the virtual space such that a horizontal level of the 360 degree camera 200 is maintained and the north direction is 0 degrees in the virtual space, on the basis of the acceleration, inclination, and orientation of the 360 degree camera 200 that are detection results by the 9-axis sensor of the information acquisition unit 10.

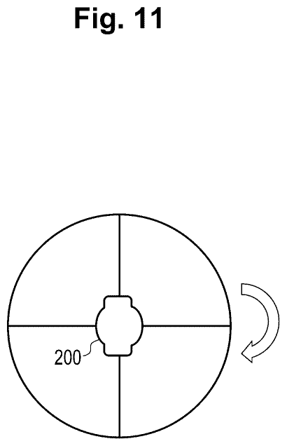

For example, as illustrated in FIG. 11 that is a side view of the virtual sphere, the video output unit 40 rotates the virtual sphere so that inclination in the horizontal direction of the 360 degree camera 200 is 0 degrees in the virtual space.

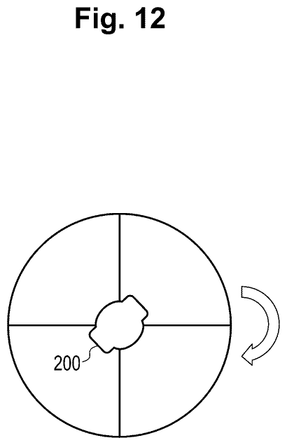

Then, as illustrated in FIG. 12 that is a top view of the virtual sphere, the video output unit 40 rotates the virtual sphere so that the north direction coincides with 0 degrees in the virtual space.

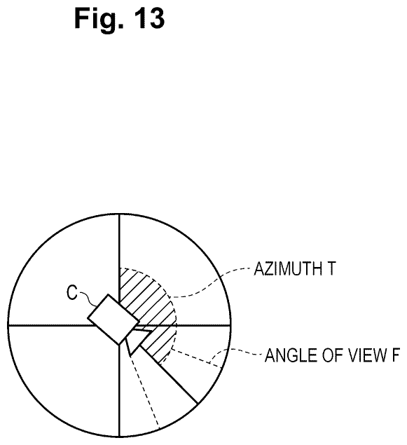

Next, as illustrated in FIG. 13 that is a top view of the virtual sphere, the video output unit 40 arranges a virtual camera C for video output at the center of the virtual sphere.

The video output unit 40 rotates the virtual camera C in accordance with an azimuth T from the virtual camera C to the target player that can be captured by the designated camera angle.

The video output unit 40 changes an angle of view F of the virtual camera C in accordance with a distance between the virtual camera C and the target player. The angle of view F is manually set in advance as several patterns.

In a case where the distance between the virtual camera C and the target player is relatively short, the video output unit 40 switches the angle of view F of the virtual camera C to a relatively large angle of view. On the other hand, in a case where the distance between the virtual camera C and the target player is relatively long, the video output unit 40 switches the angle of view F of the virtual camera C to a relatively small angle of view. The video output unit 40 cuts out the planar video on the basis of the azimuth from the camera to the target player and the distance between the camera and the target player as described above with respect to the 360 degree video captured with the switched angle of view F.

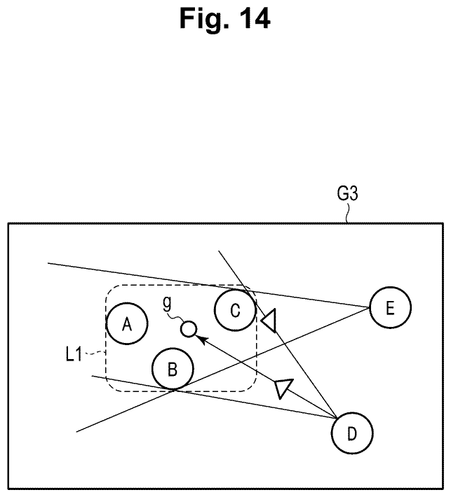

Next, a description will be given of selection of a camera angle at which a plurality of players can be captured from a third-party viewpoint as a first modification of the present embodiment. FIG. 14 is a diagram illustrating an example of selection of a camera angle at which a plurality of players can be captured from a third-party viewpoint.

Here, a description will be given of an example in which the information integration/extraction unit 20 regards a plurality of players having close distances to each other as a group of target players and displays camera angles regarding the target players on the display device of the UI unit 30 as map information.

The user can collectively select, among the plurality of players displayed by the map information, a plurality of players having relatively close distances to each other as a group of desired target players by a click operation on the screen of the UI unit 30.

In the example illustrated in FIG. 14, when a plurality of players A, B, and C on the screen is selected by a click operation on a screen G3 on the UI unit 30 by the user (see reference sign L1 in FIG. 14), the information integration/extraction unit 20 calculates a center of gravity g in latitude and longitude of the selected plurality of players A, B, and C, and sets coordinates of the center of gravity g as coordinates of a group of target players that can be captured from a camera D or E.

Then, the information integration/extraction unit 20 sets a camera angle of an effective camera capable of capturing and displaying the plurality of selected players A, B, and C from a third-party viewpoint on the basis of an azimuth from the camera D or E to the center of gravity g by a method similar to that in a case where the target player is one player, displays information regarding the camera angle again on the screen of the UI unit 30, and receives selection of a desired camera angle regarding a group of desired target players by the user.

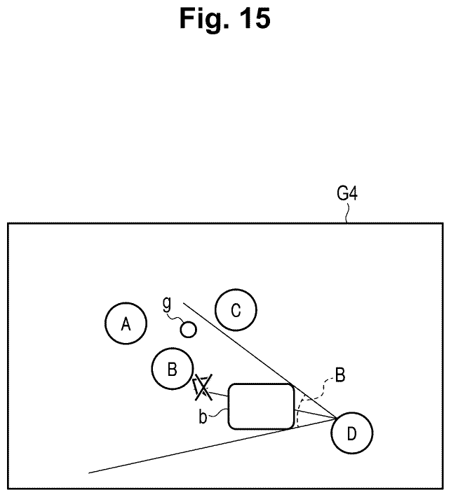

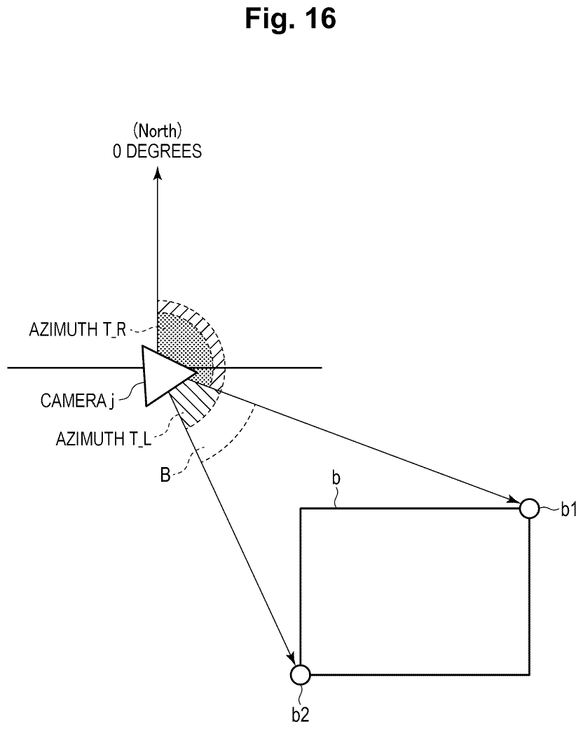

Next, a description will be given of setting of a blind spot range using position information on an obstacle as a second modification of the present embodiment. FIGS. 15 and 16 are diagrams each illustrating an example of the setting of the blind spot range using the position information on the obstacle.

In the example illustrated in FIG. 15, it is indicated that an obstacle b is arranged between the center of gravity g in the latitude and longitude of the players A, B, and C also described in FIG. 14, that is, the coordinates of a group of target players and the camera D, and on the display screen of the UI unit 30, a screen G4 is displayed in which the blind spot range B due to the obstacle b occurs at the camera angle by the camera D due to influence of the obstacle b.

The information integration/extraction unit 20 can set in advance position information and size of an obstacle that may cause a blind spot of the video captured by the camera, for example, latitude and longitude of four corners of a bounding box surrounding the obstacle. Then, the information integration/extraction unit 20 grasps a blind spot range by the obstacle for each time series, and reflects the range on the screen for selecting a desired camera described above.

In the example illustrated in FIG. 16, an example is illustrated in which the obstacle b is present at the camera angle of the camera j. This example illustrates an azimuth T_R from an orientation with 0 degrees north as a reference to an orientation from the camera j to an upper right end b1 in the figure of the bounding box of the obstacle b (may be referred to as an azimuth from the camera j to the end b1), and an azimuth T_L (<T_R) from the orientation with 0 degrees north as the reference to an orientation from the camera j to a lower left end b2 in the figure of the bounding box of the obstacle b (may be referred to as an azimuth from the camera j to the end b2). In addition, this example illustrates that an azimuth obtained by subtracting the azimuth T_R from the azimuth T_L corresponds to the blind spot range B of the obstacle b for the camera angle of the camera j.

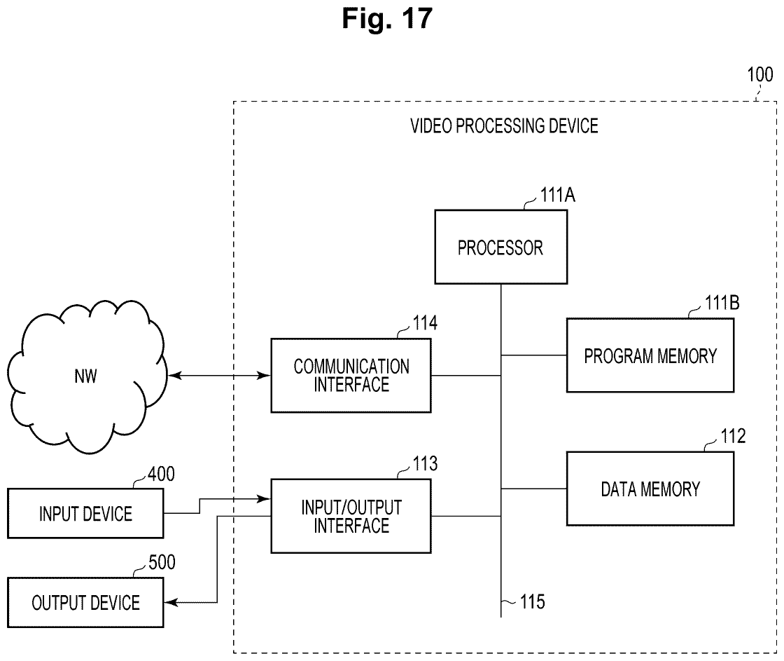

FIG. 17 is a block diagram illustrating an example of a hardware configuration of the video processing device according to the embodiment of the present invention.

In the example of FIG. 17, the video processing device 100 according to the above-described embodiment includes, for example, a server computer or a personal computer, and includes a hardware processor 111A such as a central processing unit (CPU). In addition, a program memory 111B, a data memory 112, an input/output interface 113, and a communication interface 114 are connected to the hardware processor 111A via a bus 115. The same applies to each of the information acquisition units 10.

The communication interface 114 includes, for example, one or more wireless communication interface units and enables transmission/reception of information to/from a communication network NW. As a wireless interface, for example, an interface is used in which a low-power wireless data communication standard such as a wireless local area network (LAN) is adopted.

The input/output interface 113 is connected to an input device 400 and an output device 500 that are attached to the video processing device 100 and are used by a user or the like.

The input/output interface 113 can perform processing of fetching operation data inputted by a user or the like via the input device 400 such as a keyboard, a touch panel, a touchpad, or a mouse, and outputting output data to the output device 500 including a display device using liquid crystal, organic electro luminescence (EL), or the like to display the output data. Note that the input device 400 and the output device 500 may be devices included in the video processing device 100 or may be an input device and an output device of another information terminal that can perform communication with the video processing device 100 via the network NW.

The program memory 111B is used as a non-transitory tangible storage medium, for example, as a combination of a non-volatile memory on which writing and reading can be performed as necessary, such as a hard disk drive (HDD) or a solid state drive (SSD), and a non-volatile memory such as a read only memory (ROM), and stores programs necessary for executing various kinds of control processing according to the embodiment.

The data memory 112 is used as a tangible storage medium, for example, as a combination of the above-described non-volatile memory and a volatile memory such as a random access memory (RAM), and is used to store various kinds of data acquired and created in a process in which various types of processing are performed.

The video processing device 100 according to the embodiment of the present invention can be configured as a data processing device including the information integration/extraction unit 20, the UI unit 30, and the video output unit 40 illustrated in FIG. 1 as processing function units by software. The same applies to each of the information acquisition units 10.

Each information storage unit used as a working memory or the like by each unit of the video processing device 100 can be configured by using the data memory 112 illustrated in FIG. 17. Here, these configured storage areas are not essential configurations in the video processing device 100, and may be areas provided in, for example, an external storage medium such as a universal serial bus (USB) memory or a storage device such as a database server provided in a cloud.

All of the processing function units in the units of the information integration/extraction unit 20, the UI unit 30, and the video output unit 40 can be achieved by causing the hardware processor 111A to read and execute the program stored in the program memory 111B. Note that some or all of these processing function units may be implemented in other various forms including an integrated circuit such as an application specific integrated circuit (ASIC) or a field-programmable gate array (FPGA). The same applies to each of the information acquisition units 10.

In addition, the methods described in each embodiment can be stored in a recording medium such as a magnetic disk (e.g. Floppy (registered trademark) disk or hard disk), an optical disc (e.g. CD-ROM, DVD, or MO), or a semiconductor memory (e.g. ROM, RAM, or flash memory) as a program (software means) which can be executed by a computing machine (computer) and can be distributed by being transmitted through a communication medium. Note that the programs stored in the medium also include a setting program for configuring, in the computing machine, software means (including not only an execution program but also a table and a data structure) to be executed by the computing machine. The computing machine that implements the present device executes the above processing by reading the programs recorded in the recording medium, constructing the software means by the setting program as needed, and controlling operation by the software means. Note that the recording medium in the present specification is not limited to a recording medium for distribution, and includes a storage medium such as a magnetic disk or a semiconductor memory provided inside the computing machine or in a device connected via a network.

Note that the present invention is not limited to the above-described embodiment and various modifications may be made in the implementation stage without departing from the gist of the invention. In addition, embodiments may be implemented in a combination as required, and in that case, effects can be obtained by combination. Furthermore, the above-described embodiment includes various inventions, and various inventions can be extracted by combinations selected from a plurality of disclosed components. For example, even if some components are deleted from all the components described in the embodiment, a configuration from which the components are deleted can be extracted as an invention in a case where the problem can be solved and the advantageous effects can be obtained.

### REFERENCE SIGNS LIST

100 Video processing device
10 Information acquisition unit
20 Information integration/extraction unit
30 User interface (UI) unit
40 Video output unit
200 360 degree camera

1. A video processing device, comprising:
calculation circuitry that calculates capturing directions of videos in which a subject is captured from third-party viewpoints by a plurality of 360 degree cameras on a basis of position information on the subject and position information on the plurality of 360 degree cameras each capturing a video in a range of 360 degrees around;
selection circuitry that selects a capturing direction in which a desired subject by a user who is not the subject is captured from a third-party viewpoint and that is a desired capturing direction by the user, from the capturing directions calculated by the calculation circuitry; and
output circuitry that outputs a video in a range including the desired subject in a video captured by one of the 360 degree cameras capable of performing capturing in the capturing direction selected by the selection circuitry.

2. The video processing device according to claim 1, wherein the calculation circuitry:
calculates, as a capturing direction of a video in which the subject is captured from a third-party viewpoint, a capturing direction when an azimuth of a capturing range is not included in a blind spot range that is a range in which the subject is not correctly captured, among capturing directions of the plurality of 360 degree cameras.

3. The video processing device according to claim 1, wherein the calculation circuitry:
calculates, as a capturing direction of a video in which the subject is captured from a third-party viewpoint, a capturing direction by one of the 360 cameras having a relatively close distance to the subject when a difference in azimuths of capturing ranges of the respective plurality of 360 degree cameras with respect to the subject satisfies a condition and is small.

4. The video processing device according to claim 1, wherein:
the calculation circuitry further calculates visual information in which positional relationships between a plurality of the subjects and the capturing directions calculated are indicated in a map format, and
the selection circuitry selects a capturing direction in which a desired subject by the user who refers to the visual information is captured from a third-party viewpoint and that is a desired capturing direction by the user, from the capturing directions calculated by the calculation circuitry.

5. The video processing device according to claim 1, wherein:
the calculation circuitry further calculates thumbnails of the videos in which the subject is captured from the third-party viewpoints in the capturing directions calculated for the subject in videos captured by the 360 degree cameras, and
the selection circuitry selects a capturing direction in which a desired subject by the user who refers to the thumbnails is captured from a third-party viewpoint and that is a desired capturing direction by the user, from the capturing directions calculated by the calculation circuitry.

6. A video processing method, comprising:
calculating capturing directions of videos in which a subject is captured from third-party viewpoints by a plurality of 360 degree cameras on a basis of position information on the subject and position information on the plurality of 360 degree cameras each capturing a video in a range of 360 degrees around;
selecting a capturing direction in which a desired subject by a user who is not the subject is captured from a third-party viewpoint and that is a desired capturing direction by the user, from the capturing directions calculated; and
outputting a video in a range including the desired subject in a video captured by one of the 360 degree cameras capable of performing capturing in the capturing direction selected.

7. The video processing method according to claim 6, wherein the calculating includes:
calculating, as a capturing direction of a video in which the subject is captured from a third-party viewpoint, a capturing direction when an azimuth of a capturing range is not included in a blind spot range that is a range in which the subject is not correctly captured, among capturing directions of the plurality of 360 degree cameras.

8. A non-transitory computer readable medium storing a video processing program for causing a processor to perform the method of claim 6.
